(19) United States
(12) Patent Application Publication
(10) Pub. No.: US 2007/0286673 A1
(43) Pub. Date: Dec. 13, 2007

(54) METHOD FOR FASTENING PLATE-LIKE MEMBERS AND FASTENING STRUCTURE FOR PLATE-LIKE MEMBERS

(76) Inventors: Keiji Ishino, Tokyo (JP); Takafumi Kondo, Atsugi-shi (JP); Yoshio Takahashi, Atsugi-shi (JP); Hirokazu Kurihara, Atsugi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/687,977

(22) Filed: Mar. 19, 2007

(30) Foreign Application Priority Data
Mar. 20, 2006 (JP) 2006-076453

(51) Int. Cl. F16B 5/00

(52) U.S. Cl. 403/311

(57) ABSTRACT

A method for fastening plate-like members, including the steps of: forming a convex part on a surface of one plate-like member; forming a through-hole which has a larger diameter than a diameter of the convex part in another plate-like members; after inserting the convex part through the through-hole, pressing a top surface of the convex part with a first pressurizing tool which includes at least one pointed end portion having a smaller contour than a contour of the convex part to make a cut matching the at least one pointed end portion of the first pressurizing tool at the top surface of the convex part; further pressing to expand an outer portion of the cut outwardly by means of a second pressurizing tool; and fastening the two plate-like members mutually by sandwiching in the vicinity of the through-hole of the other plate-like member by means of an expanded portion formed on the convex part and the surface of the one plate-like member.

### BACKGROUND OF THE INVENTION

1. Field of the Invention

The present invention relates to a fastening method for mutually fastening, for example, two plate-like members, especially metal plates, and a fastening structure which fastens such plate-like members.

2. Description of the Related Art

As a structure for fixing a member to a metal plate, JP 2001-129623A proposes a structure which has a shaft-like protruding portion with a specific shape on a surface of the metal plate and a part is fixed to the protruding portion of the structure.

However, in the structure mentioned above, since the shape of the shat-like protruding portion is complex, and it requires man-hours to perform the molding process of the shaft-like protruding portion, and further, since the shaft-like protruding portion is made by compression forming, and wear-out of the metal mold and so on is great making the total mold cost including maintenance high, such a structure is not economical to manufacture.

Therefore, in JP 2004-376741, filed by the same applicant, the following technology is proposed. That is to say, as an example of a case in which two plate-like members are fastened mutually, as illustrated in FIG. 8, the technology includes the steps of: forming a convex part 2 on a surface of one plate-like member 1, and forming a through-hole 4 which has a larger diameter than a diameter of the convex part 2 in another plate-like member 3, and after inserting the convex part 2 through the through-hole 4, pressing a head of the convex part 2 to expand rightward and leftward by a punch 5, and then the two plate-like members 1 and 3 are fastened mutually by sandwiching in the vicinity of the through-hole 4 of the plate-like member 3 by means of an expanded portion and the surface of the plate-like member 1.

However, in the technology disclosed in JP 2004-376741, there is a problem in that when the head of the convex part 2 is pressed to expand rightward and leftward by the punch 5, if the pressure is not applied uniformly rightward and leftward, and the plate thickness of the plate-like member 3 in which the through-hole 4 is formed is thin, the vicinity of the through-hole 4 of the plate-like member 3 is distorted and the two plate-like members 1 and 3 can not be fastened with high accuracy.

In addition, even in a case where the two plate-like members 1 and 3 are fastened without distortion, the atmospheric temperature decreases to be lower than the temperature when fastening in a state where the stress remains in the vicinity of the through-hole 4 of the plate-like member 3, and further, the plate-like member 3 shrinks and the internal stress surpasses the strength of the material, distortions occur (especially at a low temperature) and required functions may not be achieved.

### SUMMARY OF THE INVENTION

At least one object of the present invention is to provide a fastening method for plate-like plates which is capable of fastening, for example, two plate-like plates mutually with high accuracy and is not influenced by a temperature change, and to provide a fastening structure for plate-like members.

A method for fastening plate-like members according to an aspect of the present invention includes the steps of: forming a convex part on a surface of one plate-like member; forming a through-hole which has a larger diameter than a diameter of the convex part in another plate-like member; after inserting the convex part through the through-hole, pressing a top surface of the convex part with a first pressurizing tool which includes at least one pointed end portion having a smaller contour than a contour of the convex part to make a cut matching the at least one pointed end portion of the first pressurizing tool at the top surface of the convex part; further pressing to expand an outer portion of the cut outwardly by means of a second pressurizing tool; and fastening the two plate-like members mutually by sandwiching in the vicinity of the through-hole of the other plate-like member by means of an expanded portion formed on the convex part and the surface of the one plate-like member.

According to the above-mentioned method and structure, the outer portion of the cut is pressed to expand outwardly by the second pressurizing tool, therefore, the pressure is applied to the outer portion of the cut uniformly, and even in a case where the plate thickness of the other plate-like member in which the through-hole is formed is thin, it is possible to fasten the two plate-like members with high accuracy without distortion occurring in the vicinity of the through-hole of the other plate-like member. Moreover, because the vicinity of the through-hole of the other plate-like member does not become distorted, no stress remains in the vicinity of the through-hole, and thus it is not influenced by the temperature change either.

In accordance with an embodiment of the present invention, the first pressurizing tool includes a tool which has the at least one pointed end portion formed by a vertical surface of a central axis side wall surface of the tool, and an inclined surface of an outside wall surface of the tool.

According to the above-mentioned method and structure, it is possible to reduce an interval between pointed and portions, and thus the invention can be realized even when the convex part of the one plate-like member is reduced and/or the through-hole of the other plate-like member is reduced.

In accordance with an embodiment of the present invention, the first pressurizing tool includes a tool which has the at least one pointed end portion formed by inclined surfaces of the central axis side wall surface and the outside wall surface of the tool.

According to the above-mentioned method and structure, the strength of the pointed end portion can be improved.

A method for fastening plate-like members according to another aspect of the present invention includes the steps of: forming a convex part on a surface of one plate-like member; forming a through-hole which has a larger diameter than a diameter of the convex part in another plate-like member; after inserting the convex part through the through-hole, pressing a top surface of the convex part with a pressurizing tool which includes at least one pointed end portion having a smaller contour than a contour of the convex part and at least one flat portion located outside the at least one pointed end portion to make a cut matching the at least one pointed end portion of the pressurizing tool at the top surface of the convex part; further pressing to expand an outer portion of the cut outwardly by the pressurizing tool; and fastening the two plate-like members mutually by sandwiching in the vicinity of the through-hole of the other plate-like member by means of an expanded portion fastened on the convex part and the surface of the one plate-like member.

According to the above-mentioned method and structure, it is possible to achieve an effect that fastens the two plate-like members with only one pressurizing tool, in addition to the effect mentioned above.

In accordance with another embodiment of the present invention, the pressurizing tool includes a tool which has the at least one pointed end portion formed by inclined surfaces of a central axis side wall surface and an outside wall surface of the tool, and at least one flat portion located outside the outside wall surface.

According to the above-mentioned method and structure, the strength of the pointed end portion can be improved.

In accordance with a further embodiment of the present invention, the convex part is formed on the surface of the one plate-like member by pressing and half die cutting a back surface side of the one plate-like member.

According to the above-mentioned method and structure, it is possible to form the convex part on the surface of the one plate-like member easily.

In accordance with a further embodiment of the present invention, the fastening strength between the two plate-like members is adjusted by controlling the cut size when making the cut along the at least one pointed end portion at the top surface of the convex part.

According to the above-mentioned method and structure, it is possible to control the fastening strength when fastening the members, therefore it is possible to obtain a required fastening strength easily.

In accordance with a further embodiment of the present invention, an impression of the cut made by the at least one pointed end portion remains at the circumference of the convex part, when the outer portion of the cut is pressed to expand outwardly.

According to the above-mentioned method and structure, it is possible to reliably achieve a required fastening condition.

In accordance with a further embodiment of the present invention, an impression of the cut made by the at least one pointed end portion is obliterated at the circumference of the convex part, when the outer portion of the cut is pressed to expand outwardly.

According to the above-mentioned method and structure, it is possible to reliably achieve a required fastening condition.

A fastening structure which fastens one plate-like member and another plate-like member according to a further aspect of the present invention includes: a convex part formed on a surface of the one plate-like member, and a through-hole formed in the other plate-like member that receives the convex part of the one plate-like member, wherein an expanded portion where the circumference of the convex part is expanded outwardly is formed at the convex part when the convex part is inserted through the through-hole, and the two plate-like members are fastened mutually by sandwiching in the vicinity of the through-hole of the other plate-like member by means of the expanded portion and the surface of the one plate-like member.

In accordance with a further embodiment of the present invention, in the one plate-like member, a concave part is formed on a back side of the one plate-like member where the convex part is formed.

In accordance with a further embodiment of the present invention, an impression of a wedge-shaped cross-section remains at the circumference of the convex part.

### BRIEF DESCRIPTION OF THE DRAWINGS

The invention will be described further below with reference to embodiments and the accompanying schematic drawings.

FIGS. 1A, 1B and 1C illustrate a fastening method for fastening plate-like members according to a first embodiment of the present invention. FIG. 1A illustrates a state in which a convex part of a support plate is inserted through a through-hole of a spring plate; FIG. 1B illustrates a state in which a cut is made at the convex part; and FIG. IC illustrates a state in which pressing is performed to expand an outer portion of the cut.

FIG. 2 illustrates a fastening method for fastening plate-like members according to a second embodiment of the invention.

FIGS. 3A and 3B illustrate that the cut size relative to the convex part is controllable. FIG. 3A illustrates an example of a case in which no impression of the cut remains; and FIG. 3B illustrates an example of a case in which an impression of the cut remains.

FIGS. 4A and 4B illustrate that the cut size relative to the convex part is controllable in a case in which a concave part is not formed on a back side of the support plate. FIG. 4A illustrates an example of a case in which no impression of the cut remains; and FIG. 4B illustrates an example of a case in which an impression of the cut remains.

FIGS. 5A and 5B illustrate shapes of pointed end portions located at a lower portion of a punch. FIG. 5A illustrates an example of a case in which a central axis side wall surface has a vertical surface and an outside wall surface has an inclined surface; and

FIG. 5B illustrates an example of a case in which both of the central axis side wall surface and the outside wall surface have an inclined surface.

FIG. 6 illustrates an image development section of an image-forming device.

FIG. 7 is a perspective view illustrating a spring member fastened to the support plate.

FIG. 8 illustrates a method for fastening plate-like members according to a conventional technology.

### DETAILED DESCRIPTION THE PREFERRED EMBODIMENTS

### Embodiment 1

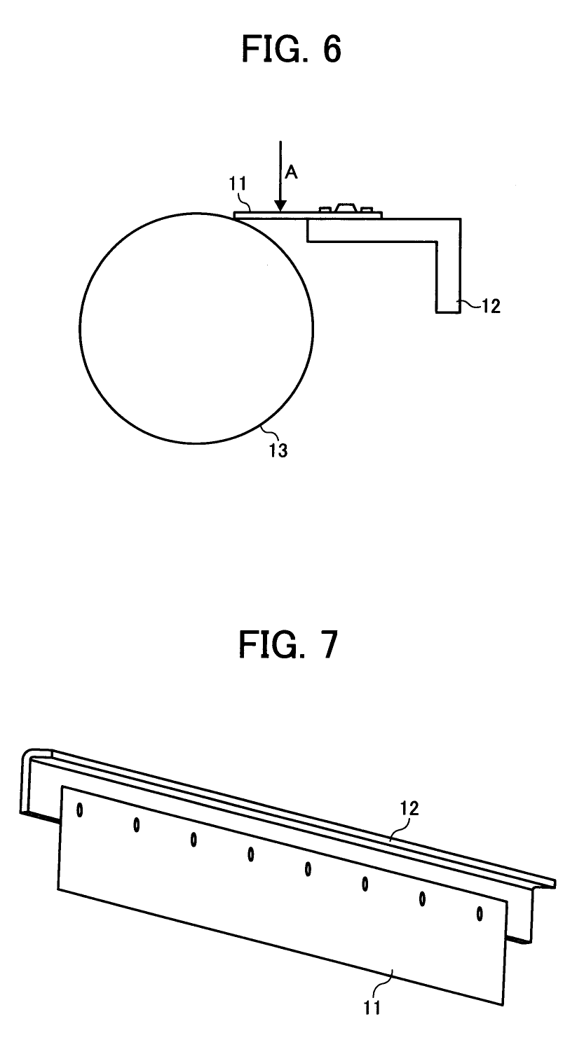

FIG. 6 illustrates an image development section of an image-forming device. In the image development section, a spring member 11 which is a thin plate is supported by a support plate 12 having a cross-section in an “L” shape, and the spring member 11 presses a photoreceptor drum 13 in a direction shown by an arrow “A” illustrated in FIG. 6.

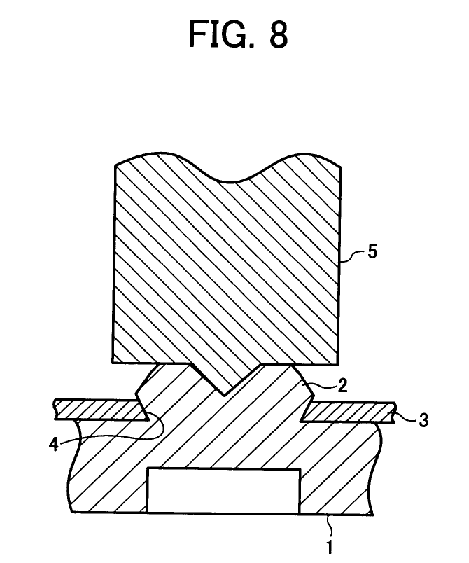

FIG. 7 illustrates the spring member 11 fastened to the support plate 12. A fastening method for fastening plate-like members (or a fastening structure for plate-like members) according to an embodiment of the present invention is used, for example, in a case that fastens the spring member 11 to the support plate 12.

Since a uniform pressing force applied to an end portion of the spring member 11 is required, the spring member 11 is used after being fastened to a holder member with the strength. To obtain the uniform pressing force in the fastening, numerous fastening locations and high straightness at the end of the spring member are necessary, and corrugation of the end and so on should not be generated. In addition, an ambient working temperature of the spring member 11 can not be specified, and a steady pressing force which is not influenced by a temperature change is required.

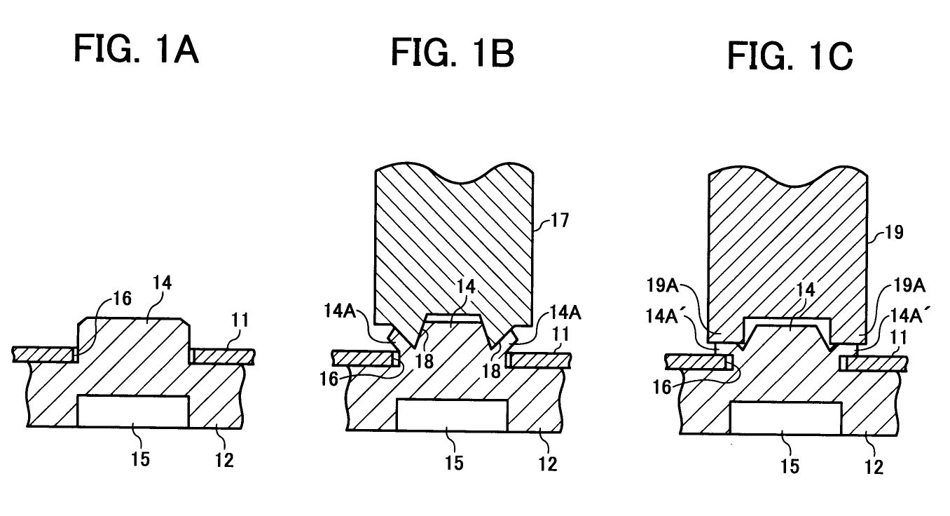

As illustrated in FIG. 1A, a convex part 14 is formed on the support plate 12 (one plate-like member). The convex part 14 is formed by pressing and half die cutting a back surface of the support plate 12, and thus a concave part 15 is formed at the back surface of the support plate 12.

A through-hole 16 which has a larger diameter than a diameter of the convex part 14 is formed in the spring plate 11 (another plate-like member), and the convex part 14 is inserted through the through-hole 16 from a back surface side of the spring plate 11. In this state, as illustrated in FIG. 1B, a top surface of the convex part 14 is pressed from above by a first punch 17 (a first pressurizing tool).

At least one pointed end portion 18 having a smaller contour than a contour of the convex part 14 is provided at a lower surface of the first punch 17, and a cut matching the pointed end portion 18 is made at the top surface of the convex part 14 by the pointed end portion 18. Therefore, an outer portion of a cut 14A is formed in the vicinity of the circumference of the convex part 14. In addition, it is possible to control the fastening strength between the spring plate 11 and the support plate 12 by controlling the cut size at this time, as mentioned later.

Next, the first punch 17 is replaced with a second punch 19 (a second pressurizing tool), which has a ring-shaped projection part 19A at its lower end part. The outer portion of the cut 14A is pressed by the second punch 19 and expanded outwardly, and then the vicinity of the through-hole 16 of the spring plate 11 is sandwiched by means of an expanded portion 14A′ and a top surface of the support plate 12.

### Embodiment 2

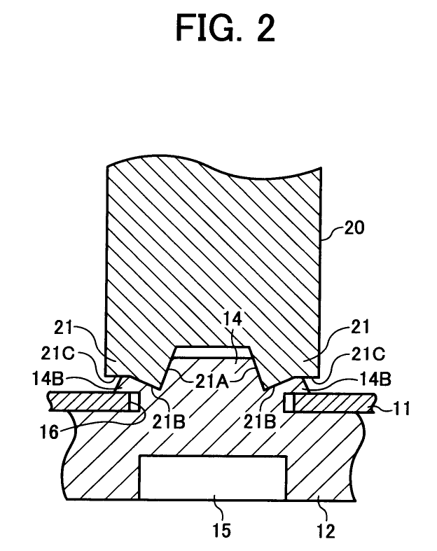

FIG. 2 illustrates a fastening method for fastening plate-like members according to the second embodiment of the present invention. In the second embodiment, a process of making a cut at the top surface of the convex part 14 and a process of pressing in order to expand an outer portion of the cut 14B are both performed by one punch 20. That is to say, the punch 20 includes at least one pointed end portion 21 and at least one flat portion 21C at its lower part. Here, the pointed end portion 21 is formed by inclined surfaces of a central axis side wall surface 21A and an outside wall surface 21B of the punch 20, and the flat portion 21C is located outside the outside wall surface 21B.

According to the above-mentioned structure, when the top surface of the convex part 14 is pressed by the punch 20, a cut is made at the top surface of the convex part 14 by the pointed end portion 21, and the outer portion of the cut 14B is pressed so as to expand outwardly, and further, the outer portion of the cut 14B is pressed from above by the flat portion 21C of the punch 20. In this way, the vicinity of the through-hole 16 of the spring plate 11 is sandwiched by means of the outer portion of the cut 14B and the top surface of the support plate 12 and as a result the spring plate 11 and the support plate 12 can be fastened mutually.

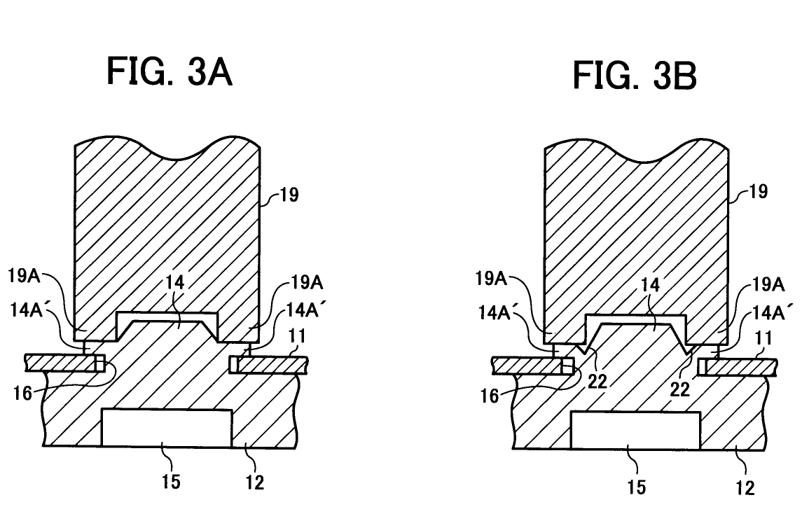

FIGS. 3A and 3B illustrate, according to the first embodiment, the point where the cut size can be controlled when the cut is made at the convex part 14 by the punch 19. That is to say, in FIG. 3A, the cut size is made small, and an impression of the cut does not remain at the circumference of the convex part 14, whereas in FIG. 3B, the cut size is made large, therefore, an impression of the cut 22 (wedge-shaped cross-section) remains at the circumference of the convex part 14. In addition, FIG. 3B illustrates the same view as FIG. 1C.

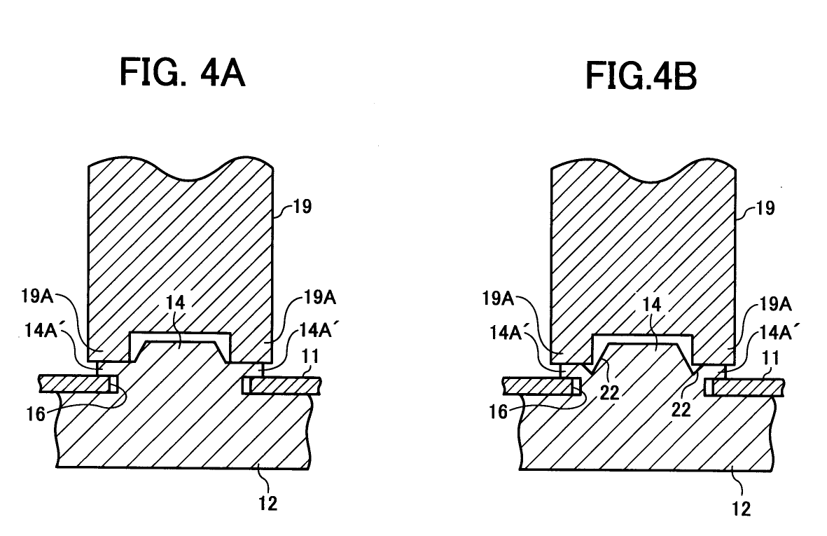

Further, FIGS. 4A and 4B illustrate an example in which, in the first embodiment, when the spring plate 11 is fastened to the support plate 12 in a state in which its lower surface has no concave part (i.e. corresponding to a concave part 15 illustrated in FIG. 1C) formed, control of the cut size is made by the punch 19 at that time. And as illustrated in FIG. 4A, the cut size is made small, and an impression of the cut does not remain at the circumference of the convex part 14, whereas in FIG. 4B, the cut size is made large, therefore, an impression of the cut 22 (wedge-shaped cross-section) remains at the circumference of the convex part 14.

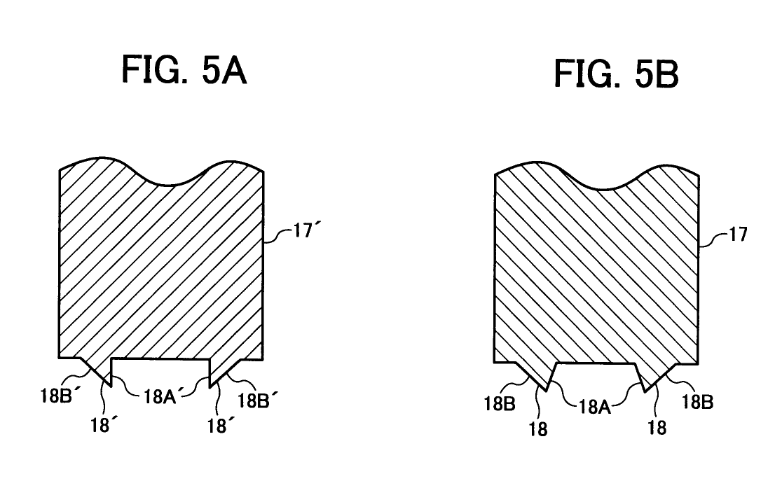

Furthermore, FIGS. 5A and 5B illustrate an example of a case in which, in the first embodiment, a shape of the pointed end portion 18 (or 18′) located at the lower portion of the punch 17 (or 17′) is changed In FIG. 5A, a pointed end portion 18′ of a punch 17′ is formed by a vertical surface of a central axis side wall surface 18A′ and an inclined surface of an outside wall surface 18B′ of the punch 17′. On the other hand, in FIG. 5B, the pointed end portion 18 of the punch 17 is formed by both of inclined surfaces of a central axis side wall surface 18A and an outside wall surface 18B of the punch 17.

In a case illustrated in FIG. 5A, it is possible to narrow an interval between the pointed end portions 18′, 18′, therefore, the punch 17′ corresponds to a case in which even the convex part 14 or the through-hole 16 is small. In addition, in a case illustrated in FIG. 5B, it is possible to improve the strength of the pointed end portion 18.

According to the present invention, it is possible to fasten, for example, two plate-like members mutually with high accuracy, and for the fastening strength to not be influenced by temperature change.

It should be noted that although the present invention has been described with respect to exemplary embodiments, the invention is not limited thereto. In view of the foregoing, it is intended that the present invention cover modifications and variations provided that they fall within the scope of the following claims and their equivalent.

The entire contents of Japanese patent application No. JP 2006-076453, filed on Mar. 20, 2006, of which the convention priority is claimed in this application, are incorporated hereinto by reference.

What is claimed is:

1. A method for fastening plate-like members, comprising the steps of:
forming a convex part on a surface of one plate-like member;
forming a through-hole which has a larger diameter than a diameter of the convex part in another plate-like member;
after inserting the convex part through the through-hole, pressing a top surface of the convex part with a first pressurizing tool which includes at least one pointed end portion having a smaller contour than a contour of the convex part to make a cut matching the pointed end portion of the first pressurizing tool at the top surface of the convex part;
further pressing to expand an outer portion of the cut outwardly by means of a second pressurizing tool; and
fastening the two plate-like members mutually by sandwiching in the vicinity of the through-hole of the other plate-like member by means of an expanded portion formed on the convex part and the surface of the one plate-like member.

2. A fastening method according to claim 1, wherein the first pressurizing tool comprises a tool which has the at least one pointed end portion formed by a vertical surface of a central axis side wall surface of the tool, and an inclined surface of an outside wall surface of the tool.

3. A fastening method according to claim 1, wherein the first pressurizing tool comprises a tool which has the at least one pointed end portion formed by inclined surfaces of the central axis side wall surface and the outside wall surface of the tool.

4. A fastening method according to claim 1, wherein the convex part is formed on the surface of the one plate-like member by pressing and half die cutting a back surface side of the one plate-like member.

5. A fastening method according to claim 1, wherein a fastening strength between the two plate-like members is adjusted by controlling the cut size when making the cut along the at least one pointed end portion at the top surface of the convex part.

6. A fastening method according to claim 1, wherein an impression of the cut made by the at least one pointed end portion remains at the circumference of the convex part, when the outer portion of the cut is pressed to expand outwardly.

7. A fastening method according to claim 1, wherein an impression of the cut made by the at least one pointed end portion is obliterated at the circumference of the convex part, when the outer portion of the cut is pressed to expand outwardly.

8. A method for fastening plate-like members, comprising the steps of:
forming a convex part on a surface of one plate-like member;
forming a through-hole which has a larger diameter than a diameter of the convex part in another plate-like member,
after inserting the convex part through the through-hole, pressing a top surface of the convex part with a pressurizing tool which includes at least one pointed end portion having a smaller contour than a contour of the convex part and at least one flat portion located outside the at least one pointed end portion to make a cut matching the at least one pointed end portion of the pressurizing tool at the top surface of the convex part;
pressing to expand an outer portion of the cut outwardly by means of the pressurizing tool; and
fastening the two plate-like members mutually by sandwiching in the vicinity of the through-hole of the other plate-like member by means of an expanded portion formed on the convex part and the surface of the one plate-like member.

9. A fastening method according to claim 8, wherein the pressurizing tool comprises a tool which has the at least one pointed end portion formed by inclined surfaces of a central axis side wall surface and an outside wall surface of the tool, and at least one flat portion located outside the outside wall surface.

10. A fastening method according to claim 8, wherein the convex part is formed on the surface of the one plate-like member by pressing and half die cutting a back surface side of the one plate-like member.

11. A fastening method according to claim 8, wherein a fastening strength between the two plate-like members is adjusted by controlling the cut size when making the cut along the at least one pointed end portion at the top surface of the convex part.

12. A fastening method according to claim 8, wherein an impression of the cut made by the at least one pointed end portion remains at the circumference of the convex part, when the outer portion of the cut is pressed to expand outwardly.

13. A fastening method according to claim 8, wherein an impression of the cut made by the at least one pointed end portion is obliterated at the circumference of the convex part, when the outer portion of the cut is pressed to expand outwardly.

14. A fastening structure which fastens one plate-like member and another plate-like members, comprising:
a convex part formed on a surface of the one plate-like member; and
a through-hole formed in the other plate-like member which receives the convex part of the one plate-like member,
wherein an expanded portion where the circumference of the convex part is expanded outwardly is formed at the convex part when the convex part is inserted through the through-hole,
and the two plate-like members are fastened mutually by sandwiching in the vicinity of the through-hole of the other plate-like member by means of the expanded portion and the surface of the one plate-like member.

15. A fastening structure according to claim 14, wherein in the one plate-like member, a concave part is formed on a back side of the one plate-like member where the convex part is formed.

16. A fastening structure according to claim 14, wherein an impression of a wedge-shaped cross-section remains at the circumference of the convex part.
